(19) United States
(12) Patent Application Publication
(10) Pub. No.: US 2021/0344017 A1
(43) Pub. Date: Nov. 4, 2021

(54) Rechargeable Lithium-Ion Battery with Metal-Foam Anode and Cathode

(71) Applicant: CellMobility, Inc., Berkeley, CA (US)

(72) Inventors: Kicheol Hong, Busan (KR); Hyeji Park, Seoul (KR); Youngseok Song, Jeollabuk-do (KR); Kyungbae Kim, Seoul (KR); Heeman Choe, Walnut Creek, CA (US)

(21) Appl. No.: 17/261,553

(22) PCT Filed: Jul. 19, 2019
(86) PCT No.: PCT/US2019/042686

§ 371 Date: Jan. 19, 2021

Related U.S. Application Data
(60) Provisional application No. 62/700,793, filed on Jul. 19, 2018.

(51) Int. Cl. H01M 4/80; H01M 4/505; H01M 4/66; H01M 4/525; H01M 4/1395; B22F 3/11; H01M 10/0525; B22F 3/26; C22C 1/08

(52) U.S. Cl. CPC H01M 4/808; H01M 4/505; H01M 4/661; H01M 4/803; H01M 4/525; H01M 2004/028; B22F 3/1134; B22F 3/1146; H01M 10/0525; B22F 3/26; C22C 1/08; H01M 4/1395

(57) ABSTRACT

Anode and cathode electrodes of a rechargeable lithium-ion battery are manufactured using metal foam. This lithium-ion battery with the metal-foam electrodes can have pores coated or filled, or both, with high-capacity active materials for greater energy density, better safety, improved power, and longer cycle life. Aluminum (or nickel) and copper metal-foam electrodes are manufactured using space-holder and freeze-casting methods. An anode can be filled with a graphite or silicon slurry, or a combination. A cathode can be filled with a lithium cobalt oxide (or other higher-capacity active materials) slurry. The relatively thick metal-foam electrodes are attached to the cell, separated by a separator, and wetted by an electrolyte, forming a high-capacity secondary battery. The battery will have higher density, improved power, and good cycle life.

### CROSS-REFERENCE TO RELATED APPLICATIONS

This patent application claims the benefit of U.S. patent application 62/700,793, filed Jul. 19, 2018, which is incorporated by reference along with all other references cited in this application.

### BACKGROUND OF THE INVENTION

The invention relates to the field of rechargeable battery technology and more specifically, to coin-cell, pouch, and cylindrical rechargeable lithium-ion battery technology with single-piece metal-foam conductive components.

Several different types of secondary batteries are widely used and are commercially applicable as a rechargeable electrochemical energy storage system. Among these secondary batteries, a secondary lithium-ion battery (LIB) provides advantages in high performance due to the high power capacity and energy density. The use of the secondary lithium-ion battery is important in portable electronic devices such as mobile phones, laptops, digital cameras, and video camcorders.

In addition, a secondary lithium-ion battery is a great power source for automotive, hybrid cars, and electric bicycles (e-bikes), which is expected to be used effectively as a promising energy storage system (ESS) in the future. With recent technology trends, there is significant ongoing research and development in an innovative secondary lithium-ion battery to improve its capacity, power, and operating voltage (in association with energy density) in every way possible.

Therefore, there is a need for a secondary lithium-ion battery with metal foam electrode having improved capacity, power, or operating voltage, in any combination.

### BRIEF SUMMARY OF THE INVENTION

A rechargeable lithium-ion battery is manufactured with and uses metal foam for its anode and cathode electrodes. The secondary lithium-ion battery with the metal-foam anode and cathode electrodes can have pores filled with high-capacity active materials or their mixtures with standard anode (graphite) and cathode (lithium cobalt oxide or LCO) active materials for greater energy density, higher power, better safety, and longer cycle life. Aluminum or nickel metal-foam cathode and copper anode metal-foam are manufactured using space-holder and freeze-casting methods, which are subsequently coated and/or filled with graphite tin, or silicon, or a combination (anode), and lithium cobalt oxide (cathode) slurries, respectively. The two metal-foam electrodes can then be attached easily and separated by a traditional separator to form a high-capacity secondary lithium-ion battery with longer cycle life due to the containment of the high-capacity materials in the pores and effective accommodation of the corresponding volume expansion. This new battery design can provide a significant cost-saving manufacturing process of lithium-ion battery and can replace the traditional sheet-stacking battery process with better success.

In an implementation, a rechargeable battery, storage battery, or secondary battery or cell is a lithium-ion battery device. The rechargeable battery includes a cylinder-, pouch-, or disc-shaped “thick” single-piece open-cell metal-foam anode, or a combination. The battery includes one or more cathode electrodes. At least a portion or the entirety of inner pores of the anode or cathode, or both, are filled with one or more active materials that react with lithium. The anode or cathode of the battery can be formed using freeze casting or space holding.

In an implementation, a method to form a rechargeable battery uses a space-holder technique to formed a porous metal foam electrode for its anode or cathode. Salt or sodium chloride (NaCl) powder is grounded (e.g., manually grounding) or ball-milled in a ceramic mold for about 5 minutes to about 60 minutes down to evenly small (e.g., on the order of hundreds of microns). The ground sodium chloride powder is sieved through a sieve (or sift, strainer, mesh strainer, filter, or other) such that resulting powder size ranges from about 40 microns to 100 microns. Metal (e.g., graphite silicon, tin, or a mixture of graphite and silicon) and the sieved sodium chloride powder are mixed or ball milled for about 5 minutes to about 60 minutes.

The mixture of metal and sodium chloride powder is pressed using a room-temperature presser for about 1 minutes to about 30 minutes under the pressure of about 10 to 100 megapascals. The pressed mixture powder of metal and sodium chloride is sintered at about 400 to 650 degrees Celsius for about 30 minutes to several hours (e.g., 2-3 hours, 3-4 hours, 3-4 hours, or 3-6 hours) in a nitrogen, vacuum, or argon atmosphere, or a combination. The sodium chloride powder is dissolved away in water or any another salt-dissolving liquid using sonicator for about 10 minutes to several hours (e.g., 2-3 hours, 3-4 hours, 3-4 hours, or 3-6 hours), leaving behind precisely controlled pores in metal foam.

In an implementation, a rechargeable battery is assembled from metal foams as both the anode and cathode electrodes. The metal foam is fabricated by a freeze casting or space holder technique. The fabricated metal-foam anode and cathode electrodes are wet with electrolyte and assembled together in the form of a cylinder, disc, or coin and are separated by a separator.

Other objects, features, and advantages of the present invention will become apparent upon consideration of the following detailed description and the accompanying drawings, in which like reference designations represent like features throughout the figures.

### BRIEF DESCRIPTION OF THE DRAWINGS

FIG. 1 shows a schematic diagram of the traditional lithium-ion battery anode and cathode manufacturing process (layer-by-layer stacking process).

FIGS. 2A-2C show scanning electron micrographs of a high-capacity anode material.

FIG. 3 shows a schematic of an improved new lithium-ion battery manufacturing process with a metal-foam anode and cathode electrodes.

FIGS. 4A-4C show various examples of lithium-ion battery cells using “single-piece” copper foam anode and aluminum (nickel) foam cathode.

FIGS. 5A-5C show optical micrographs of examples of current collector (cathode) fabricated with space-holder technique using ball-milled and sieved sodium nitride as space holder to create regulated pores.

FIG. 6 shows a schematic illustration of a space-holder method.

FIG. 7 shows an optical micrograph of copper foam current collector (anode) fabricated with a freeze-casting technique to create regulated pores.

FIG. 8 shows an optical micrograph of aluminum foam cathode before (right) and after (left) filling of the lithium-cobalt oxide (LCO) active material.

FIG. 9 shows a comparison of schematic diagrams of traditional cylindrical and improved metal-foam-based cylindrical lithium-ion batteries.

### DETAILED DESCRIPTION OF THE INVENTION

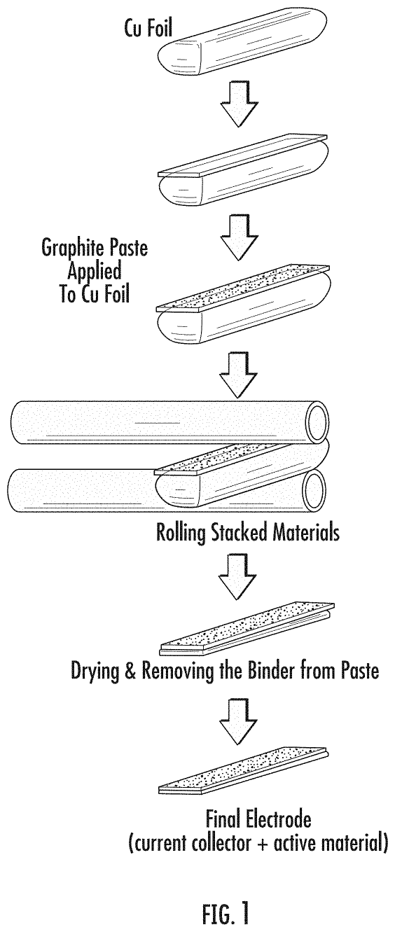

FIG. 1 shows a schematic diagram of the traditional lithium-ion battery anode and cathode manufacturing process (layer-by-layer stacking process). The lithium-ion battery design is based on two dimensional copper and aluminum foil current collector and active coatings.

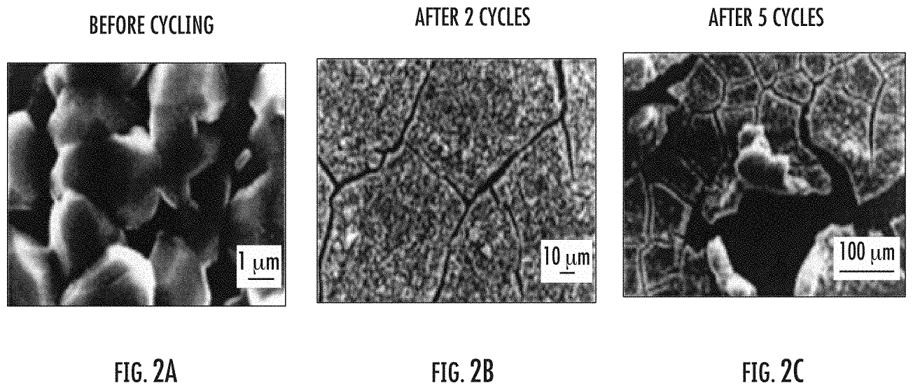

FIGS. 2A-2C show scanning electron micrographs of a high-capacity anode material (tin) before (left, FIG. 2A) and after (middle, FIG. 2B, and right, FIG. 2C) several charging or discharging cycles. Due to the large volume expansion during the charging and discharging cycling process, the high-capacity material develops cracks due to the stresses from the large volume expansion and suffers from premature failure only after a few cycles when it is used in the form of traditional two-dimensional sheet electrode.

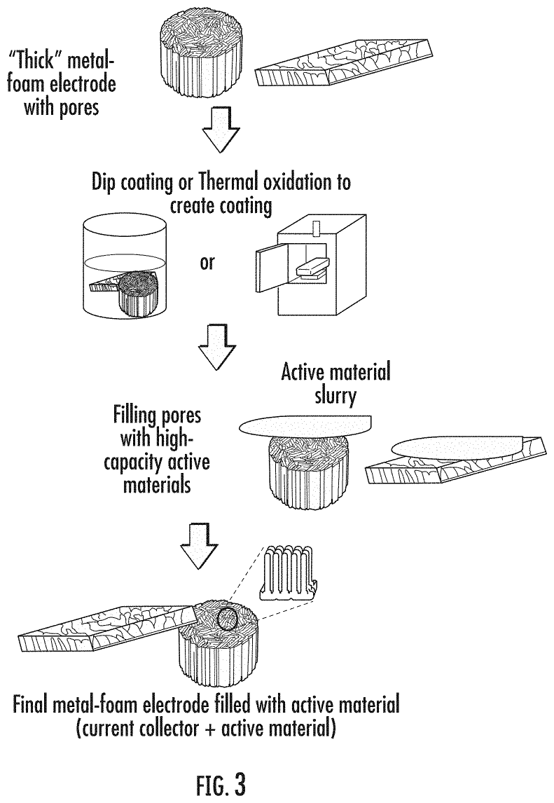

FIG. 3 shows a schematic of an improved new lithium-ion battery manufacturing process on the basis of the metal-foam anode and cathode electrodes. Note that it is not based on the traditional “sheet stacking, layer-by-layer” process, but is based on the “thick” one-piece metal-foam anode and cathode filled with active materials. Also note that the active material should be selected to be high-capacity active material because the metal-foam electrode design can withstand more volume expansion than the traditional electrode design.

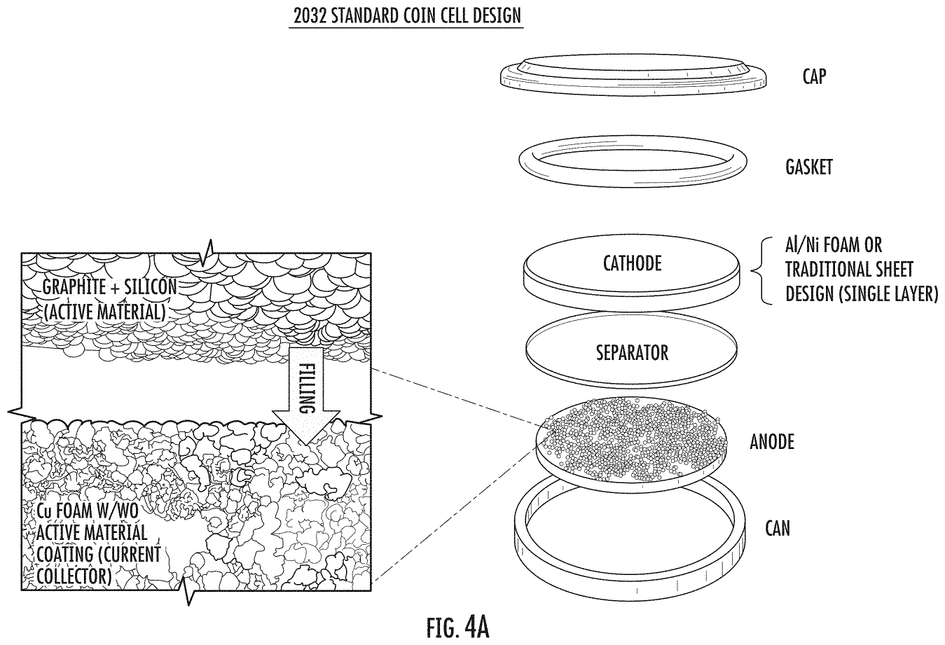

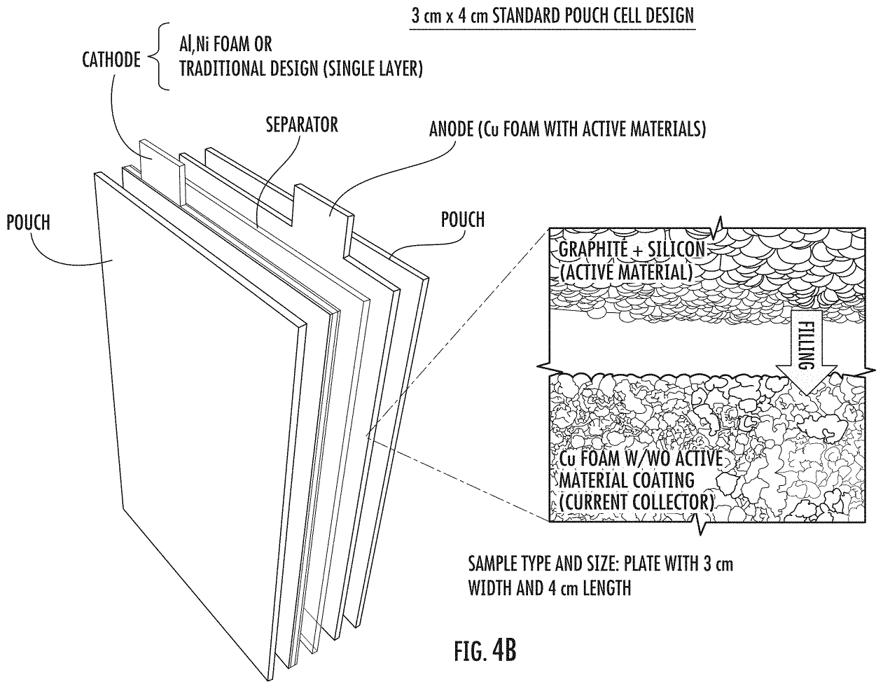

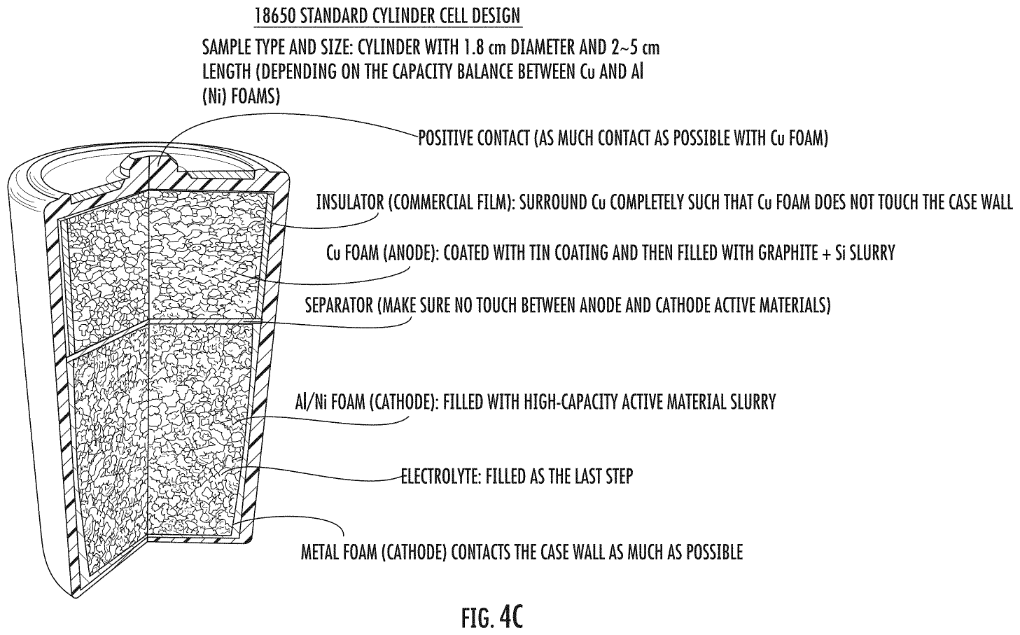

FIGS. 4A-4C show a schematic of lithium-ion battery cells using “single-piece” copper foam anode and Al (or Ni) foam cathode: (4A) standard 2032 coin cell, (4B) standard 3 centimeters by 4 centimeters pouch cell, and (4C) standard 18650 cylinder cell. It is noted that a combination of copper foam anode and aluminum foil cathode (based on traditional method) is also possible.

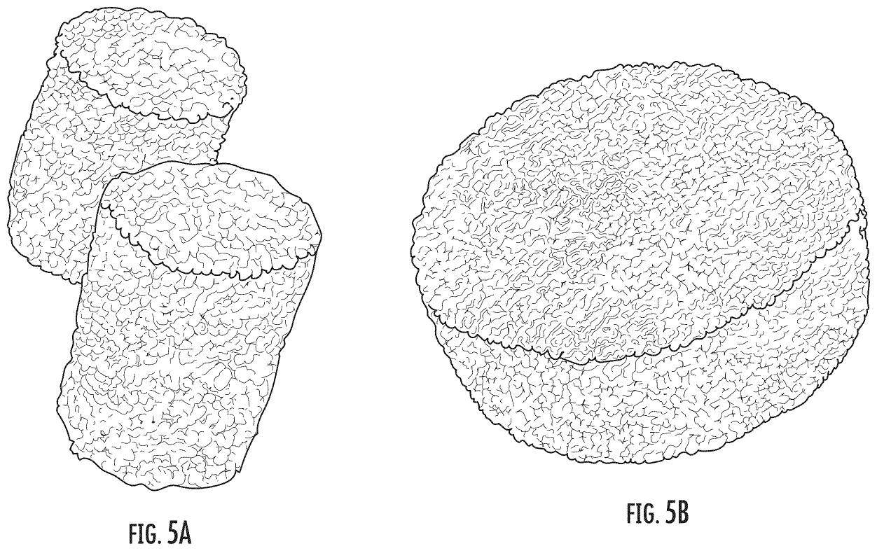

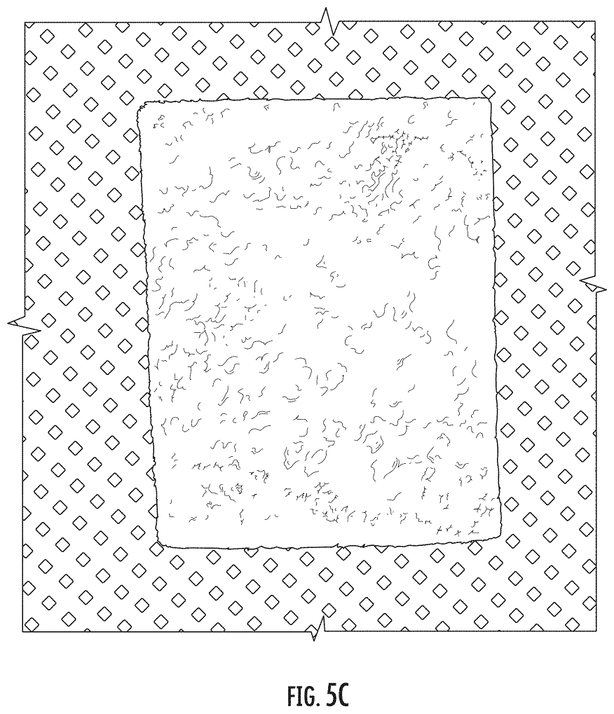

FIGS. 5A (cylinder sample) and 5B (disk) show optical micrographs of aluminum foam current collector (cathode) fabricated with space-holder technique using ball-milled and sieved sodium nitride as space holder to create regulated pores. FIG. 5C (3 centimeters by 4 centimeters pouch sample) also shows an optical micrograph of nickel foam current collector (cathode) fabricated with the same method using ball-milled and sieved sodium nitride to precisely control the pore size from about 70 microns to about 130 microns.

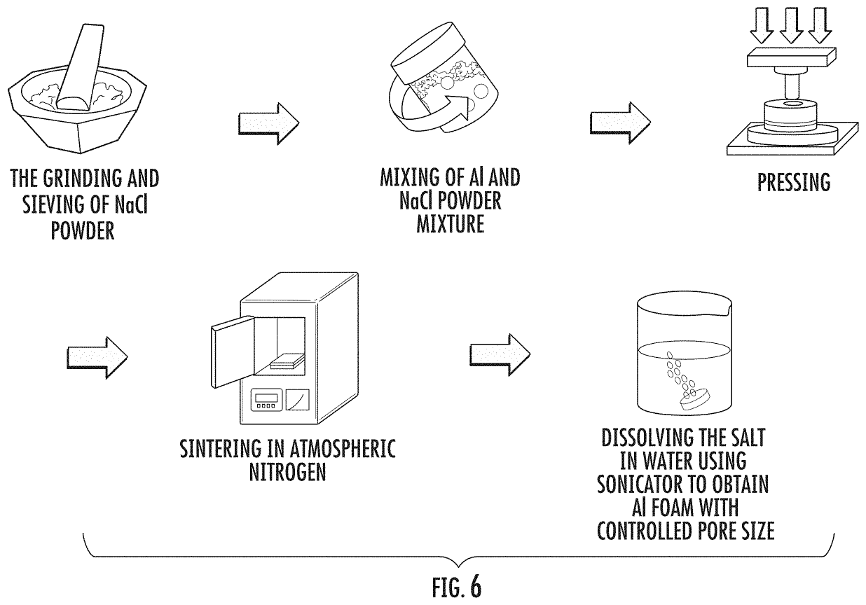

FIG. 6 shows a schematic illustration of the space-holder method. It is noted that the space-holder method can be applied to the manufacturing of copper, nickel, and aluminum foam anode and cathode electrodes. In particular, this space-holder technique is a method to create controlled pores (tens of microns) for filling of active materials into the pores; for the creation of controlled pore size, sodium nitride was ball-milled and sieved such that the proper sodium nitride powder size can be several tens of microns.

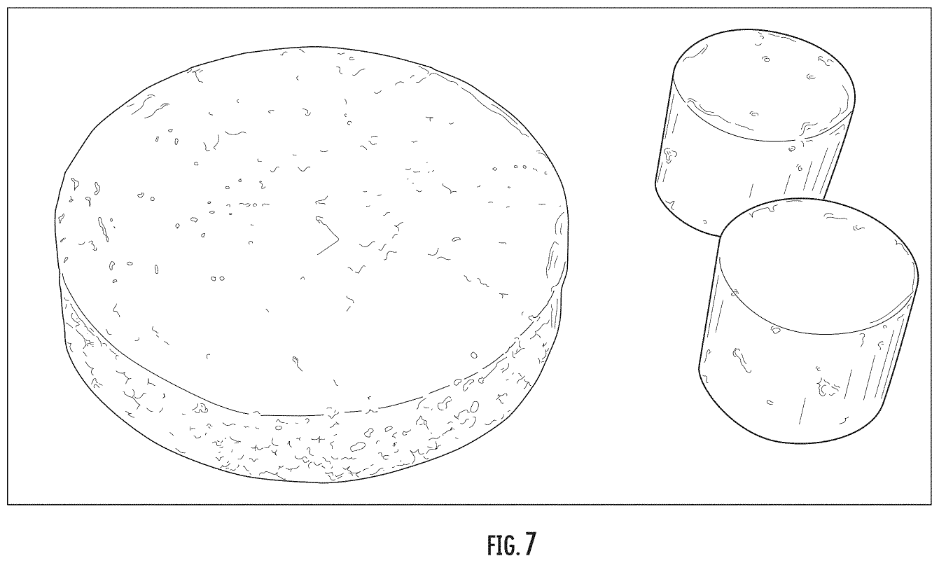

FIG. 7 shows an optical micrograph of copper foam current collector (anode) fabricated with freeze-casting technique to create regulated pores. Note that this freeze-casting technique is a method to create random or elongated pores (controlled pore size of several tens of microns). Elongated pore structure is suitable for easier filling of active material.

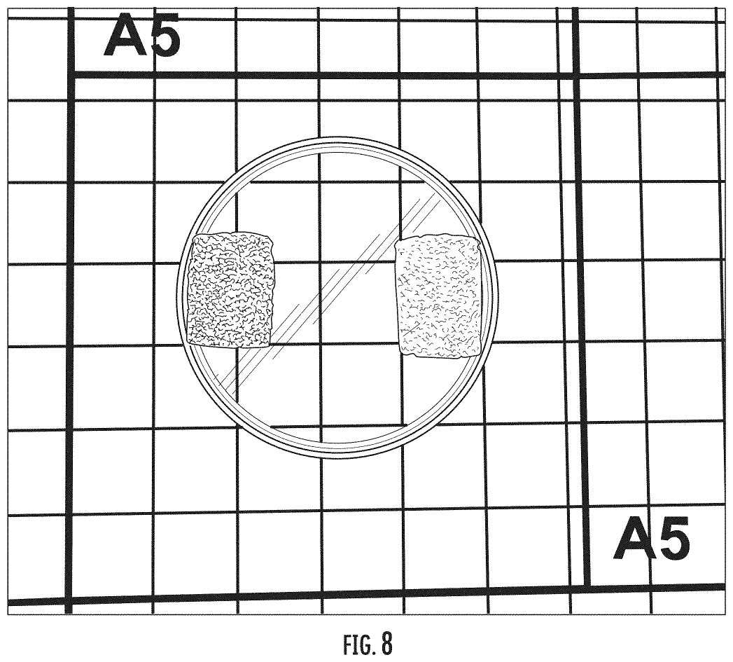

FIG. 8 shows an optical micrograph of aluminum foam cathode before (right) and after (left) filling of the lithium-cobalt oxide (LCO) active material. The LCO active material was first made in the form of a slurry mixed with water, binder, and conductive material. It was then filled into the pores of the aluminum foam.

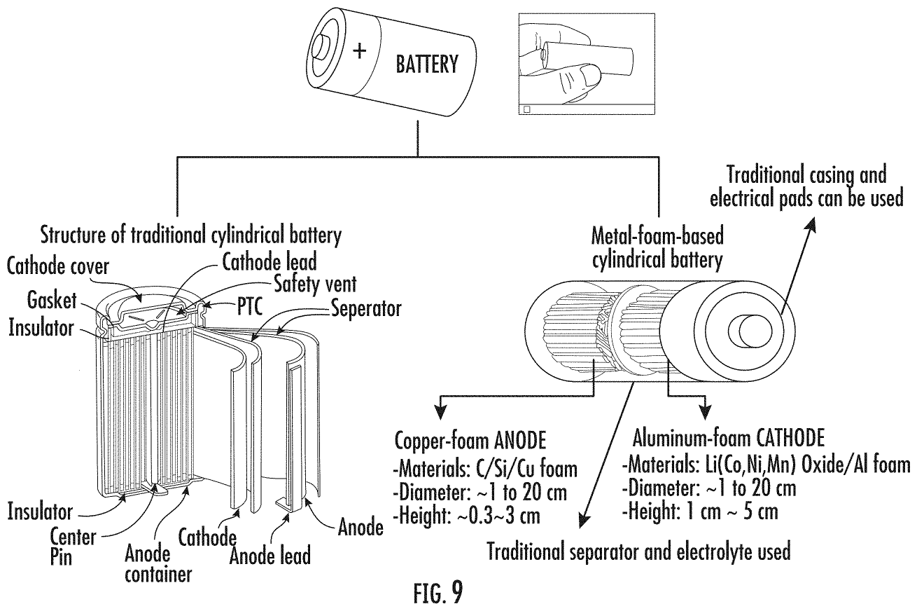

FIG. 9 shows a comparison of schematic diagrams of traditional cylindrical and improved metal-foam-based cylindrical lithium-ion batteries. Note that high-capacity materials filled up in the pores of the metal-foam anode and cathode provides higher energy density and safety along with longer cyclic battery life, as they can be sustained better in this battery design.

This patent describes the use of metal foams for the electrode of secondary lithium-ion battery, preparing method thereof, active material coating and filling method thereof, and secondary lithium-ion battery including the metal foam anode and cathode. In a particular embodiment, the developed technique relates to metal foam for use in the electrode of secondary lithium-ion battery where the surface and the inner pore walls are coated or filled, or both, with the active materials (especially, high-capacity active materials), a method of manufacturing such metal foam, a method of completely filling the pores of such metal foam with high-capacity active materials, and secondary lithium-ion battery including the metal foams as both the anode and cathode.

This patent describes solutions to overcome the limitations discussed above. A purpose is to provide metal foams and their three-dimensional structure for the anode and cathode electrodes of newly designed lithium-ion batteries, which exhibit superior capacity, safety, and cycling characteristics and significantly improved charge and discharge efficiency. Here, the assembly of the metal-foam anode and cathode is not based on the traditional “sheet stacking” process where thin layers of anode and cathode materials and their current collector foils are stacked together layer-by-layer, but is based on the “thick” anode and cathode electrodes with three dimensionally connected pores (e.g., see FIG. 3); here, single-piece thick anode and cathode electrodes are attached together, being separated by a traditional separator to result in standard coin cell (FIG. 4A), pouch cell (FIG. 4B) or cylinder cell (FIG. 4C), although one anode and two cathode pieces can also be assembled together due to generally much greater high-capacity active materials available for the anode than for the cathode. It is also emphasized that there is no limitation in stacking additional anode and cathode electrodes on top of each other to enhance the entire energy density of the cell, if required. Additionally, various methods and structures are described, including a method of preparing such metal foam structured electrode, a method of filling such metal foam electrode with active materials for improved capacity and safety, and a new design of lithium-ion battery including the metal foams as both the anode and cathode.

The useful characteristics of the metal foam originate from the fact that the high-capacity active materials can be coated or filled, or both, in-between the struts of anode and cathode metal foams and provide a significantly simpler battery design without the traditional sheet stacking process, as the traditional two-dimensional design has serious limitation in utilizing high-capacity active materials. The loss of active material by fall-off or degradation can be minimized during multiple cycles of operation because of the metal foam's ability to properly accommodate the stresses due to the volume expansion. Any manufacturing technique is acceptable for the metal-foam electrodes, although precisely controlled pore size is important (preferably less than a few hundred microns). Among many other processing methods of open-cell metal foams, space-holder technique and freeze-casting technique yield good results, because they provide cheap, easy processing route, and large-sized samples, which also has excellent capability of mass production. Selection of the preferred processing method also depends on the required pore amount and size for the active-material filling process of the metal-foam electrode, and capacity and safety design of the electrode to be used for the choice of application.

This patent describes the use of metal foam as an electrode of a secondary lithium-ion battery, manufacturing methods of open-porous metal foam, preparing method thereof, a method of filling active materials into the precisely controlled pores, and an assembly method of secondary lithium-ion battery including the metal foam anode and cathode electrodes. In an embodiment, the developed technique relates to metal foam with decent thickness for an electrode of a secondary lithium-ion battery where the metal foam is fabricated using space holder technique (e.g., FIGS. 5A, 5B, and 6) or freeze casting (e.g., FIG. 7), and its inner pores are completely filled with high-capacity active materials [e.g., FIG. 8 (right: before filling; left: after filling)], including a method of assembling such metal foams and a secondary lithium-ion battery including the metal foams as both anode and cathode of the standard 18650 cylinder cell (e.g., FIG. 9).

In an implementation, metal foams for the anode and cathode electrodes of a secondary lithium-ion battery are provided such that they include a regularly-spaced pore structure capable of containing high-capacity (e.g., silicon, tin, transition-metal oxide, and others) active materials on the surface and in the inner pores of the metal foam. The metal-foam anode and cathode are then attached to each other, being separated by a traditional separator, wet by a traditional electrolyte, and cased and electrically connected as in the conventional coin (FIG. 4A), pouch (FIG. 4B), and cylindrical battery cell design (FIGS. 4A and 9). Therefore, this new battery design based on the metal-foam anode and cathode accommodates the stresses and strains developed during the volume expansion of a high-capacity active material in charging of lithium ions, which thus leads to better safety, higher capacity, excellent cycling characteristics, and exceptionally improved charge or discharge efficiency, or both.

There is an urgent need for new concepts for electrode design because a significantly improved performance of secondary lithium-ion battery generally originates from the improvement in the microstructural design and physical or chemical characteristics, or both, of the cathode and anode. The conventional cathode and anode material designs have been fabricated using the following “layer-by-layer” steps.

First, slurry is prepared by mixing an active material, a conductive material, and a binder, along with some other minor materials in some cases. The slurry is then applied on a metallic current collector in the form of a thin film, which is subsequently dried and pressed at room temperature.

FIG. 1 has usually less than 100 microns in thickness. Here, a single layer electrode is never or rarely used in actual battery devices due to its insufficient capacity; instead, numerous layers are stacked together (layer-by-layer design) to maximize its capacity and energy density. This “two-dimensional” cathode and anode electrode design has been the traditional core technology in lithium-ion battery industry, resulting in serious limitations against further dramatic improvement.

In this case, the current collector plays a vital role as an electrode support along with an electron acceptor and donor. It is therefore highly desirable to enlarge the contact area and minimize the contact resistance between the metallic current collector and active material using a new three-dimensional metal-foam electrode design in order to improve electrode performance by accepting or donating electrons as efficiently as possible.

A few attempts have been reported in the use of the three-dimensional metal-foam electrode design in the battery industry; however, the use of the metal-foam electrode containing uniformly distributed microscale pores (pore size usually less than a few hundreds of microns but ideally several tens of microns) is important in achieving decent capacity, cyclic stability, and power for the actual battery device.

In a conventional electrode design, the two-dimensional current collector film and active material coating can cause a problem of exfoliation of the coated materials (graphite anode and lithium oxide cathode active materials) from the current collectors, especially when higher-capacity anode and cathode active materials are used due to the significant volume expansion during the charging or discharging cycling process.

In other words, during the actual charging and discharging cyclic operations, the two-dimensional sheet-based coating materials degrade and fall off due to stresses caused by volume expansion (the higher capacity, the higher volume expansion; e.g., up to 300 percent for silicon) and results in premature cyclic failure (e.g., FIG. 2). The degradation and fall-off of the high-capacity anode and cathode active materials (e.g., graphite anode containing tin or silicon) sometimes cause short circuit and safety issues. Solutions are presented to overcome the limitations as stated above. Porous metal foam containing uniform distribution of sufficiently small pores (several tens of microns in size) is used based on its three dimensionally connected design, as an innovative electrode filled with a high-capacity materials such as tin, silicon, and others, which can thus accommodate stresses and strains developed during charging or discharging cycling, or both, and provide safer batteries.

### Solution to Problems

The battery technology of this patent provides the following benefits: To provide an innovative new battery design with simpler manufacturing steps, better safety, higher capacity, and longer cyclic life than the traditional two-dimensional “sheet” stacking manufacturing process; three-dimensional “thick” metal foams with regulated open pores (as opposed to the “thin” traditional foil electrodes) are used for the anode and cathode of a secondary lithium-ion battery where the surface is coated or the inner pores are filled, or both, with high-capacity active materials in the form of powder slurry; any processing method of producing porous metal foam with pore size ranging from several tens of microns to a few hundred microns would be acceptable considering the common slurry particle size and diffusion distance in the pore; on the other hand, space-holder (e.g., FIG. 5) and ice-templating (e.g., FIG. 6) techniques appear to be very attractive because they possess excellent capability of mass production and micro-scale pore size controllability.

A preparing method of metal foam is described for use as the anode and cathode electrodes of an innovative secondary lithium-ion battery where all of the surface and the inner pores are coated or filled, or both, with high-capacity active materials (e.g., graphite and silicon powders slurry for the anode electrode). One embodiment of the method includes a filling process of the metal foam with the active material.

A secondary lithium-ion battery is described such that it includes the metal foam as an electrode (both anode and cathode). Herein, the metal foam examples are copper foam for anode (e.g., FIG. 7) and aluminum (e.g., FIGS. 5A and 5B) or nickel (FIG. 5C) foam for cathode electrodes, and have regularly-spaced open pores on the order of several to a few hundreds of microns, which can be fabricated by any processing method of producing open-porous metal foams including space-holder and freeze-casting methods.

Influence of New Battery Electrode Design Technology

Metal foams are provided for use as the anode and cathode electrodes of an innovative, simple secondary lithium-ion battery design that includes a porous structure capable of containing high-capacity active materials filled into the inner pores of the metal foam. The three-dimensional-structured metal foam with sufficiently small pore size (on the order of tens of microns) has significantly higher contact area between the current collector and active material compared to the metal foil that has been conventionally used as a current collector with the two-dimensional coating of an active material. Furthermore, this three-dimensional metal-foam current collector design can withstand the large volume expansion during the charging or discharging process, or both, of lithium-ion battery, and thus leads to higher energy density, excellent cycling characteristics, and exceptionally improved charge or discharge efficiency, or both.

A lithium-ion battery with three-dimensional-structured metal foams as the anode and cathode electrodes on the order of several hundreds to thousands microns would not have sufficiently small pore sizes. However, when pore sizes are not sufficiently small enough, these materials cannot be used in high-performance lithium-ion batteries where the diffusion distance from the center of the pore to the metal-foam current collector is also considerably large. However, according to techniques described in this application, the resulting three-dimensional-structured metal foams as the anode and cathode electrodes have small pores of several tens to a few hundreds microns in size. When the coating and filling is properly performed, the capacity, power, and the cycling stability of the lithium-ion battery significantly improves.

In an implementation, the metal foam cylinders (e.g., FIGS. 4A, 4C, and 5A), disks (e.g., FIG. 5B), and pouch (e.g., FIGS. 4B and 5C) with decent thickness (from about 0.2 millimeters to 50 millimeters) for use as the anode and cathode electrodes of a secondary lithium-ion battery are successfully fabricated using space-holder or freeze-casting technique with the right range of porosity (between 70 percent and 90 percent) and are filled with high-capacity active materials (e.g., silicon-added graphite powder). It is noted that even the 0.2-millimeter thickness of the “thick” metal-foam electrode is considerably thick, as compared to the typical thickness of the traditional foil electrode with active material coating (about 0.05 millimeters). The entire pieces of the metal-foam anode and cathode are attached together (but separated by a separator and wet with electrolyte as in the traditional battery) to form a secondary lithium-ion battery that can provide high capacity, high power, better safety, and longer cyclic life, as opposed to the traditional lithium-ion battery with the two-dimensional sheet-stacking design usually suffering from premature failure with the use of high-capacity active materials.

An implementation includes the filling method of the active materials capable of intercalating and deintercalating lithium ions, or storing and separating lithium ions through alloying or conversion reaction. The active material may be a cathode or an anode active material whose particle size is about 10 microns or less. The cathode active material should be a compound capable of reversibly intercalating or deintercalating lithium. The cathode active material is not particularly limited as long as it can be used for a cathode of a secondary lithium-ion battery. For example, cathode active materials can be NCM-based materials such as LCO(LiCoO₂), LMO(LiMn₂O₄), LMO(LiMn₂₄LiFeO₄), LFP(LiFePO₄), OLO(Li₂MnO.LiMO₂), and LiNi_{1/3}Co_{1/3}Mn_{1/3}O₂. Additionally, the anode active material includes a material capable of reversibly intercalating or deintercalating lithium; and it should be an anode active material known in the art, which is used for an anode of a secondary lithium-ion battery. The anode active material is not particularly restricted and it can be selected from a group of the following materials: low-crystalline carbon-based materials including artificial graphite, natural graphite, soft carbon, hard carbon, and metals (Sn, Si) or metal alloys including Si—Li based alloys, In—Li based alloys, Sb—Li based alloys, Ge—Li based alloys, Bi—Li based alloys, Ga—Li based alloys, and oxide based materials including SnO₂, Co₃O₄, CuO, NiO, and Fe₃O₄. For example, a graphite slurry added with silicon or tin powder can be filled into the pores of the copper foam anode.

An implementation provides a new lithium-ion battery design based on metal-foam anode and cathode electrodes filled with active materials (especially, high-capacity active materials). When the metal foam structure serves as a current collector, it is possible to supply electrons as a reacting means or transport electrons to external circuit by accumulating electrons generated by electrochemical reactions. The material that can be used for manufacturing the metal foam includes but not limited to: aluminum, nickel, nickel-copper alloy, copper, gold, titanium, stainless steel (SUS), or their alloys. It is desired to fabricate the anode current collector with the copper or nickel foam and the cathode current collector with the aluminum or nickel foam, mainly because of their high electrical conductivity, easiness of manufacturability, and appropriate electrochemical potentials.

The manufacturing process of the porous metal foam is not restricted to a single method but can be achieved via various metal-foam processing methods, such as powder sintering, space holder methods, freeze casting, dealloying, electroplating, electroless plating, or chemical vapor deposition. However, this invention emphasizes the techniques including space-holder and freeze-casting methods, because they can provide a properly small range of pore size (several tens of microns to a few hundreds of microns) and are easy for mass production.

The space-holder technique (e.g., FIGS. 5A-5C) includes mixing the space holder and metal powder together, eventually removing the space holder, and leaving behind the pore spaces; here, it is important that the space holder powder is in the right range of size, preferably between tens of microns and a few hundreds of microns, by ball-milling and sieving for example. For example, after a heat treatment or chemical treatment on the ball-milled or sieved and pressed mixture of prepared salt powder (salt particles ground down to evenly small size) and metal powder, the salt powder just acts as a space holder and can be rinsed and removed at a later stage. Prior to the removal of the salt powder, high-temperature sintering is applied to the mixture of the pressed metal and salt powder (e.g., FIG. 6). In addition, polymer particles or low melting-point metals such as tin, magnesium, or zinc can also be used as a space holder, since they can be molten away.

Freeze-casting technique (e.g., FIG. 7) includes the following steps. First, make a slurry by mixing metal powder with water and binder (also dispersant if needed). Then, immerse the copper rod into liquid nitrogen and control the temperature at the copper rod. A mold is prepared on the copper rod by wrapping polytetrafluoroethene (PTFE) (e.g., Teflon) or vinyl around the copper top portion and then the slurry is poured in it. Once the powder slurry is frozen between the ice dendrites, one can dry the ice below the freezing point using a freeze dryer. Then, the green-body foam structure will be formed in the space formerly occupied by the ice dendrites. Use of liquid nitrogen in the cooling step with the metal rod leads to a faster cooling rate and results in relatively small pores, on the order of several tens to a few hundreds of microns in diameter. Some parameters that can affect the results of this process include the metal powder size, binder type, heat-treatment temperature. Three dimensionally constructed metal foam will be formed once the porous green body is sintered at a high temperature. An advantage of using freeze casting is that a directional porous structure can be obtained such that the filling of the active material slurry into the pores can be more effective.

There are various aspects of an implementation of the space-holder method.

As an example of making such a secondary lithium-ion battery with metal foams as both anode and cathode electrodes, the following space-holder process can be used (e.g., FIG. 6):

(a) Commercial sodium chloride powder (e.g., salt) in a mold is manually ground for about 20-30 minutes, which is subsequently sieved down to evenly small (on the order of several tens to a few hundreds of microns) particle size, preferably between about 30 microns and 100 microns considering the active material particle size and diffusion distance in the metal-foam pore.

(b) Aluminum and the sieved sodium chloride powders are mixed and ball-milled for about 30 minutes.

(c) The mixture of the Al powder and sodium chloride powder is pressed using a room-temperature presser for about 30 minutes.

(d) The pressed mixture powder of metal and sodium chloride is then sintered at about 600-650 degrees Celsius for several hours in a nitrogen atmosphere.

(e) The sodium chloride powder is finally dissolved away in water using sonicator, leaving behind regulated, controlled pores in the aluminum foam.

A method of preparing metal foam is provided for use as an electrode of a secondary lithium-ion battery where all of the inner pores are occupied by the active material, and the method includes a process of coating or filling, or both, the metal foam pores with the active material.

The filling of the pores in the metal-foam anode and cathode electrodes can be done by a gravity-fed process in which a slurry of active material powders (e.g., graphite slurry added with high-capacity silicon powder) is dropped on top of the metal-foam anode. The slurry then slowly penetrates into the metal-foam pores by its gravity and is dried after its complete filling; and this process can be repeated until complete filling. Here, it is important to have open surface pores of the metal foam. Additionally, the metal-foam electrode may be wet with water or coated with an active material prior to the gravity feeding of the slurry to reduce the surface tension of the metal foam; and the gravity-feeding process may be carried out at a temperature higher than room temperature to decrease the viscosity of the slurry and help the slurry penetrate the pores more smoothly. A vacuum-pulling device may also be applied from the bottom of the metal-foam electrode to aid the active material slurry with better filling of the pores; during the vacuum pulling process, the slurry fills the vacuumed pores of the metal-foam electrode. This process can be repeated until the complete filling is achieved.

A secondary lithium-ion battery includes the metal foams for use as both anode and cathode electrodes where some or all of the inner pores of the metal foam are coated or filled, or both, with the active materials as discussed above.

Secondary lithium-ion batteries include a cathode, an anode, a separator membrane, and an electrolyte. The cathode and anode electrodes are characterized such that they consist of metal foam electrodes plus current collector of the battery electrode system where some or all of the inner pores are coated or filled, or both, with the active materials (e.g., FIG. 3). Prior to the filling of the pores with active materials, some or all of the inner pores may be coated with metal-oxide or metallic active material (e.g., tin) to further increase the energy density of the metal-foam electrode, but the coating process is optional (e.g., FIG. 3).

Furthermore, in an implementation, a secondary lithium-ion battery includes a metal-foam cathode (e.g., aluminum or nickel foam), a metal-foam anode (e.g., copper or nickel foam), an electrolyte, and a separator membrane; here, the electrolyte and the separator are not part or made of the metal-foam electrodes but can be manufactured by a conventional method and composition already known in the art, without any particular restriction. Polymers used in a separator membrane are polyolefin-based porous films including polyethylene and polypropylene. The organic solvent is selected from a group consisting of the one or more of the following: propylene carbonate (PC), ethylene carbonate (EC), dimethyl carbonate (DMC), ethyl methyl carbonate (EMC), butylene carbonate, benzonitrile, acetonitrile, tetrahydrofuran, 2-methyl tetrahydrofuran, dioxolan, 4-methyl dioxolan, N-dimethyl formamide, dimethyl amide acetonitrile, dimethyl sulfoxide, dioxane, 1,2-dimethoxyethane, sulfolane, dichloroethane, chlorobenzene, nitrobenzene, diethyl carbonate, methyl propyl carbonate, methyl isopropyl carbonate, ethyl, butyl carbonate, dipropyl carbonate, diisopropyl carbonate, dibutyl carbonate, diethylene glycol, dimethyl ether.

Examples of lithium salts are LiPF₆, LiCF₃SO₃, Li(CF₃SO₂)₂, LiBF₄, LiClO₄, and LiN(SO₂C₂F₅)₂. The solid polymer electrolyte is composed of a lithium salt dissolved in one or a combination of more than two solvents identified above. The solid electrolyte consists of the polymers such as polyethylene oxide, polypropylene oxide, polyethyleneimine, which has a relatively-high ion conductivity to lithium ion, and it is impregnated with electrolytic solution to provide the electrolyte in the form of gel. As in the traditional lithium-ion battery's two-dimensional electrodes and foil current collectors, conventional materials can be used for the anode and cathode active materials, the conductive materials, or the binders of the present invention along with the invented metal-foam cathode and anode electrodes.

Secondary lithium-ion batteries can have various shapes such as a cylinder, disc, a square, a coin, and a pouch depending on the application of the present invention. It is desirable to emphasize that regardless of their shape, both the metal-foam anode and cathode are single-piece metal-foam current collector with decent thickness whose inner pores are filled with active materials, unlike the traditional sheet-stacking two-dimensional design. If however needed, single-piece metal-foam anode and double-piece metal-foam cathodes can also be used for the capacity balance between the anode and the cathode. For example, the two cathode metal foams are attached to the both sides of the single-piece anode metal foam to improve the capacity balance and electrochemical reactions.

While examples of the embodiments are described in some detail, those descriptions and embodiments are not intended to limit the scope of the claimed invention. For example, the space-holder technique described in FIG. 6 can also be applied to the manufacture of copper foam (or nickel foam) fabricated using freeze casting in FIG. 6.

### Embodiment 1

FIGS. 5A and 5B show micrographs of aluminum foam current collector (cathode) and FIG. 5C shows micrograph of nickel foam current collector (cathode), all of which were fabricated using space-holder technique. As shown in FIG. 6, commercial salt powder was manually ground in an alumina mold for about 20 minutes to achieve evenly small powder of sodium chloride (on the order of tens to hundreds of microns), which was then subsequently sieved to obtained precisely controlled range of sodium chloride powder size (preferably between 30 and 100 microns). Commercially available aluminum and the sieved sodium chloride powders are then mixed or ball-milled, or both, for about 30 minutes in a spex mill machine. The mixture of aluminum and sodium chloride powder is pressed using a room-temperature presser for about 10 minutes. The pressed mixture powder of aluminum and sodium chloride is then sintered at about 650 degrees Celsius for several hours in a nitrogen atmosphere. The sodium chloride powder is finally dissolved away in water using a sonicator, leaving behind regulated pores in aluminum foam with three dimensionally connected pores with controlled pore size.

### Embodiment 2

FIG. 6 shows an optical micrograph of copper foam current collector (anode) fabricated using freeze-casting technique to create regulated pores on the order of a few to several tens of microns. Note that this freeze-casting technique can create elongated, smaller-sized pores (a few to several tens of microns) for greater contact area with electrolyte and enhanced electrochemical reactions. The filling of the pores with a slurry active material may be easily achieved using a gravity-fed method (e.g., FIG. 8); on the other hand, a vacuum-pulling device may be needed for a better pore-filling process when the pore size is smaller. U.S. patent application Ser. No. 13/930,887 describes a freeze-casting technique and is incorporated by reference. This process is a simple, low-cost processing method, which is suitable for fabricating large-scale porous structure. However, the manufacturing process of the porous metal foam is not limited to the freeze-casting method.

For example, copper powder slurry, which consists of about 13.7 volume percent copper oxide powder and about 2.5 weight percent polyvinyl alcohol (PVA) binder is created by using 30 milliliter deionized water. The slurry is dissolved in the solution by stirring and using sonication. The slurry is then poured into a fluoropolymer resin or Teflon mold placed on the chilled copper rod. The temperature of the top of the copper rod is fixed at from about −10 to about −50 degrees Celsius using liquid nitrogen and maintained by using a temperature controller. Teflon is a synthetic fluorine-containing resins or fluoropolymer resins. Teflon is a trademark of Chemours Company FC, LLC. After the slurry is completely frozen, it is sublimated at about −88 degrees Celsius for about 40 hours in a freeze-dryer in vacuum, resulting in removal of the ice crystals and leaving a green body with directional pores. The green-body foam is then reduced from copper oxide to pure copper in hydrogen atmosphere and is subsequently sintered at higher temperature. Reduction and sintering processes consist of presintering at about 250 degrees Celsius for 4 hours and actual sintering at about 800 degrees Celsius for about 10 to 20 hours in a tube furnace under 5 percent hydrogen mixture gas.

### Embodiment 3

FIG. 8 shows aluminum foam cathode successfully filled with lithium cobalt oxide (LCO) powder slurry. The LCO active material slurry was first mixed with water and binder (with some carbon black when required) to be made in the form of a slurry with a right degree of viscosity. It was then placed on top of the aluminum foam and gravity-fed into the pores of the aluminum foam over a few minutes; subsequently, this process can be repeated if required.

The manufactured copper and aluminum foam electrodes can be used in the lithium-ion battery form of a cylinder, disc, pouch, coin, or other shape or form, and have improved energy density, enhanced power, improved safety, and superior cycling characteristics compared with the copper and aluminum foil-based electrodes manufactured in a traditional way. This is especially true when these foam-structure-based electrodes are filled with high-capacity active materials such as tin and silicon. In the traditional lithium-ion battery design, the repeated charge and discharge cycling can lead to the repeated volume expansion and contraction of the high-capacity active material, resulting in a premature failure due to high stresses and strains in the electrode. In this new lithium-ion battery design, the copper and aluminum (or nickel) foam current collectors will accommodate some degree of the volume change and corresponding stresses of the high-capacity active materials by containing them in their inner pores. Additionally, high-capacity coatings such as transition metal oxides or tin can be applied to the metal-foam electrode prior to the filling of an active material. When the metal foam is used as an electrode plus current collector, the interfacial resistance between the foam and active material will also be minimized owing to the inherent nature of the foam's ability to accommodate stresses and strains by utilizing the regularly-spaced porous structure.

In an implementation, a secondary lithium-ion battery device includes at least one of a cylinder-, pouch-, or disc-shaped “thick” single-piece open-cell metal-foam anode and cathode electrodes where at least a portion or the entirety of their inner pores are filled with one or more active materials that react with lithium.

The coin cells can include single-piece metal-foam anode and single-piece metal-foam cathode, being separated by traditional separator and wet by traditional liquid electrolyte. The coin cells can include a single-piece metal-foam anode (or cathode) and traditional foil cathode (or anode), respectively.

The cylinder or disk cells can include single-piece metal-foam anode and single-piece metal-foam cathode, being separated by traditional separator and wet by traditional liquid electrolyte. The cylinder or disk cells can include single-piece metal-foam anode (or cathode) and traditional foil cathode (or anode), respectively.

The pouch cells can include single-piece metal-foam anode and single-piece metal-foam cathode, being separated by traditional separator and wet by traditional liquid electrolyte. With the larger capacitor of the anode active materials, the pouch cells can include single-piece metal-foam anode and double-piece metal-foam cathode, being attached to the single-piece metal-foam anode by both sides. The pouch cells can include single-piece metal-foam anode (or cathode) and traditional foil cathode (or anode), respectively.

The metal-foam anode can be at least one of copper, titanium, iron, magnesium, tin or nickel foam, and the metal-foam cathode is at least one of aluminum, stainless steel, or nickel foam. The active materials can be anode active materials including a high-capacity material of at least one of silicon, tin, or a mixture of graphite and silicon, or a combination. The cathode active materials are selected from a group consisting of the following LCO(LiCoO2), LMO(LiMn2O4), LMO(LiMn2O4), LFP(LiFePO4), NCM(Li(NiCoMn)O2), NCA(Li(NiCoAl)O2), and OLO(Li2MnO.LiMO2).

The anode active material can include a graphite-based material, metal-based material, or oxide-based material, or a combination, and is selected from a group consisting of the following: artificial graphite, natural graphite, soft carbon, hard carbon, Sn, Si and Si—Li based alloys, In—Li based alloys, Sb—Li based alloys, Ge—Li based alloys, Bi—Li based alloys, Ga—Li based alloys, and oxide based materials including SnO2, Co3O4, CuO, NiO, and Fe3O4.

A manufacturing process to form the porous metal-foam electrode can include a freeze-casting method with controlled pore size between about 10 microns and about 150 microns.

In an implementation, a method of manufacturing process to form the porous metal-foam electrode is a space-holder method includes: at least one of grounding or ball-milling sodium chloride powder in a ceramic mold for about 5 minutes to about 60 minutes down to evenly small (on the order of hundreds of microns); sieving the ground sodium chloride powder such that the powder size ranges from 40 microns to 100 microns; at least one of mixing or ball-milling metal and the sieved sodium chloride powders for about 5 minutes to about 60 minutes; pressing the mixture of metal and sodium chloride powder using a room-temperature presser for about 1 minutes to about 30 minutes under the pressure of about 10 to 100 megapascals; sintering the pressed mixture powder of metal and sodium chloride at about 400 to 650 degrees Celsius for about 30 minutes to several hours in at least one of a nitrogen, vacuum, or argon atmosphere; and dissolving the sodium chloride powder away in water or any other salt-dissolving liquid using sonicator for about 10 minutes to several hours, leaving behind precisely controlled pores in metal foam.

The active material can include a graphite powder slurry mixed with water, binder and high-capacity active material powder such as tin and silicon (the weight percent of the high-capacity material ranges from about 0 percent to about 100 percent). The composition and viscosity of the slurry can be modified for slurry's best gravity feeding or vacuum-pulling process. The active material slurry can be placed on top of the metal-foam electrode and slowly gravity-fed into the pores of the metal foam.

This gravity-feeding filling method can be assisted with a vacuum-pulling device from the bottom of the metal-foam electrode. This process can be repeated with drying process until the filling is complete.

In an implementation, a secondary lithium-ion battery device assembled with metal foams as both the anode and cathode electrodes where the metal foam is fabricated by at least one of freeze casting or using a space holder. The fabricated metal-foam anode and cathode electrodes can be wet with electrolyte and coupled together in the form of a cylinder, disc, or coin and is also separated by a separator. Here, traditional materials can be used for the electrolyte and separator previously described. The size of the metal-foam anode and cathode electrodes can be properly varied depending on the specific application of the secondary lithium-ion battery and the comparative capacities of the used anode and cathode active materials. For example, if the graphite is used for anode and lithium cobalt oxide is used for cathode, almost twice larger amount of the cathode active material should be used than the anode active material as its capacity per weight is about half that of the anode active material. Therefore, the height of the cathode metal-foam electrode container (e.g., a cylinder) should then be twice as larger than the height of the anode metal-foam electrode container. It is of particular note that the achievement of small pore size between 30 microns and 150 microns is highly important for the metal-foam electrodes in order to maintain an effective diffusion distance of lithium-ion in the metal-foam pores to the metal-foam current collector, which can lead to sustainable high capacity and power during cycling.

This description of the invention has been presented for the purposes of illustration and description. It is not intended to be exhaustive or to limit the invention to the precise form described, and many modifications and variations may be possible in light of the teaching above. The embodiments were chosen and described in order to best explain the principles of the invention and its practical applications. This description will enable others skilled in the art to best utilize and practice the invention in various embodiments and with various modifications as are suited to a particular use. The scope of the invention is defined by the following claims.

The invention claimed is:

1. A secondary lithium-ion battery device comprising:
at least one of a cylinder-, pouch-, or disc-shaped “thick” single-piece open-cell metal-foam anode and cathode electrodes wherein at least a portion or the entirety of their inner pores are filled with one or more active materials that react with lithium.

2. The device of claim 1 wherein the coin cells comprise single-piece metal-foam anode and single-piece metal-foam cathode, being separated by traditional separator and wet by traditional liquid electrolyte.

3. The device of claim 2 wherein the coin cells comprise a single-piece metal-foam anode (or cathode) and traditional foil cathode (or anode), respectively.

4. The device of claim 1 wherein the cylinder or disk cells comprise single-piece metal-foam anode and single-piece metal-foam cathode, being separated by traditional separator and wet by traditional liquid electrolyte.

5. The device of claim 1 wherein the cylinder or disk cells comprise single-piece metal-foam anode (or cathode) and traditional foil cathode (or anode), respectively.

6. The device of claim 1 wherein the pouch cells comprise single-piece metal-foam anode and single-piece metal-foam cathode, being separated by traditional separator and wet by traditional liquid electrolyte.

7. The device of claim 6 wherein with the larger capacitor of the anode active materials, the pouch cells comprise single-piece metal-foam anode and double-piece metal-foam cathode, being attached to the single-piece metal-foam anode by both sides.

8. The device of claim 6 wherein the pouch cells comprise single-piece metal-foam anode (or cathode) and traditional foil cathode (or anode), respectively.

9. The device of claim 1 wherein the metal-foam anode is at least one of copper, titanium, iron, magnesium, tin or nickel foam, and the metal-foam cathode is at least one of aluminum, stainless steel, or nickel foam.

10. The device of claim 1 wherein the active materials can be anode active materials comprising a high-capacity material of at least one of silicon, tin, or a mixture of graphite and silicon.

11. The device of claim 1 wherein the cathode active materials are selected from a group consisting of the following LCO(LiCoO₂), LMO(LiMn₂O₄), LMO(LiMn₂O₄), LFP(LiFePO₄), NCM(Li(NiCoMn)O₂), NCA(Li(NiCoAl)O₂), and OLO(Li₂MnO.LiMO₂).

12. The device of claim 10 wherein the anode active material comprises a graphite-based material, metal-based material, or oxide-based material, or a combination, and is selected from a group consisting of the following: artificial graphite, natural graphite, soft carbon, hard carbon, Sn, Si and Si—Li based alloys, In—Li based alloys, Sb—Li based alloys, Ge—Li based alloys, Bi—Li based alloys, Ga—Li based alloys, and oxide based materials including SnO₂, Co₃O₄, CuO, NiO, and Fe₃O₄.

13. The device of claim 1 wherein a manufacturing process to form the porous metal-foam electrode comprises a freeze-casting method with controlled pore size between about 10 microns and about 150 microns.

14. A method of manufacturing process to form the porous metal-foam electrode of a rechargeable battery is a space-holder method comprising:
at least one of grounding or ball-milling sodium chloride powder in a ceramic mold for about 5 minutes to about 60 minutes down to evenly small (on the order of hundreds of microns);
sieving the ground sodium chloride powder such that the powder size ranges from 40 microns to 100 microns;
at least one of mixing or ball-milling metal and the sieved sodium chloride powders for about 5 minutes to about 60 minutes;
pressing the mixture of metal and sodium chloride powder using a room-temperature presser for about 1 minutes to about 30 minutes under the pressure of about 10 to 100 megapascals;
sintering the pressed mixture powder of metal and sodium chloride at about 400 to 650 degrees Celsius for about 30 minutes to several hours in at least one of a nitrogen, vacuum, or argon atmosphere; and
dissolving the sodium chloride powder away in water or any other salt-dissolving liquid using sonicator for about 10 minutes to several hours, leaving behind precisely controlled pores in metal foam.

15. The device of claim 10 wherein the active material comprises a graphite powder slurry mixed with water, binder and high-capacity active material powder such as tin and silicon (the weight percent of the high-capacity material ranges from about 0 percent to about 100 percent).

16. The device of claim 15 wherein the composition and viscosity of the slurry is modified for slurry's best gravity feeding or vacuum-pulling process.

17. The device of claim 15 wherein the active material slurry is placed on top of the metal-foam electrode and slowly gravity-fed into the pores of the metal foam.

18. The device of claim 17 wherein this gravity-feeding filling method is assisted with a vacuum-pulling device from the bottom of the metal-foam electrode.

19. The device of claim 17 wherein this process is repeated with drying process until the filling is complete.

20. A secondary lithium-ion battery device assembled with metal foams as both the anode and cathode electrodes wherein the metal foam is fabricated by at least one of freeze casting or using a space holder, wherein the fabricated metal-foam anode and cathode electrodes are wet with electrolyte and coupled together in the form of a cylinder, disc, or coin and are separated by a separator.
